(19) United States
(12) Patent Application Publication
(10) Pub. No.: US 2015/0100388 A1
(43) Pub. Date: Apr. 9, 2015

(54) AGGREGATED SALES AND MARKETING STRATEGY TOOL

(71) Applicant: ROI Links, LLC, Golden, CO (US)

(72) Inventors: Kathleen Dalsaso Mitchler, Golden, CO (US); John Drew Mitchler, Golden, CO (US)

(73) Assignee: ROI Links, LLC

(21) Appl. No.: 14/509,947

(22) Filed: Oct. 8, 2014

Related U.S. Application Data
(60) Provisional application No. 61/888,100, filed on Oct. 8, 2013.

(51) Int. Cl. G06Q 10/06

(52) U.S. Cl. CPC G06Q 10/0637
USPC 705/7.36

(57) ABSTRACT

The disclosure provides systems and methods pertaining to the generation of sales and marketing strategies. One embodiment provides an aggregated sales and marketing analysis and strategy system. The system includes a processing engine that is coupled to a database and at least one client device associated with a GUI dashboard. The system performs the roles of analyzing raw sales and marketing data, generating one or more sales and marketing strategies based on information obtained through the analysis, and reporting the results of the analysis as well as the sales and marketing strategies to the GUI dashboard. Other embodiments are also disclosed.

### REFERENCE TO PENDING PRIOR PATENT APPLICATION

This application claims the benefit under 35 U.S.C. 119 (e) of U.S. Provisional Patent Application No. 61/888,100, filed Oct. 8, 2013 by Kathleen Dalsaso Mitchler and John Drew Mitchler for “AGGREGATED SALES AND MARKETING STRATEGY TOOL,” which patent application is hereby incorporated herein by reference.

### BACKGROUND

Sales and marketing data is commonly collected, benchmarked, and reported by customer relationship management (CRM) tools, data warehouses, internal information technology (IT) departments, and external database vendors.

Sales and marketing raw data goes through data cleansing, standardization, appending, and coding to aggregate the data variables. The raw data is then aggregated into a useable format.

Generally, the process of reviewing and evaluating raw customer data in a manner that morphs the data into useful, reportable sales and marketing information requires a number of discrete steps. These steps are often carried out by numerous computer programs and/or manual processes, as well as different people of varying experience and skill, both internal and external to an organization, which are susceptible to bias and conflicts of interest. For example, collected customer information may be indexed and compared to established sales and marketing metrics, profiled, segmented, and/or used to establish benchmark metrics for a particular business customer or the business as a whole.

The motivation behind the collection, analysis, and reporting of raw sales and marketing data, discussed above, involves the generation of sales and marketing strategies that focus on customer retention, prospect acquisition, and market penetration. That is, once a business possesses useful information derived from its raw sales and marketing data, it may use that information as a platform in making strategic decisions for retention, acquisition, and penetration.

The process of generating and reporting sales and marketing strategies based on an analysis of a company's raw data is currently a largely manual process carried out by business leadership, industry consultants, and/or other decision makers who may or may not possess the requisite knowledge and experience and may or may not have a conflict of interest regarding company sales and marketing goals. Because people make these strategic decisions, the decisions are often impacted by inconsistencies and biases introduced through human error, judgment, preconceived opinions, experience levels, preferences, institutional politics, emotions, and more. Currently no automated system, with or without the above-discussed ability to analyze a company's raw sales and marketing data, provides automated, consistent, and unbiased strategy generation based on an analysis of that company's raw sales and marketing data.

Barriers to the creation of an automated system include the lack of a library of strategies from which to choose, a lack of decision-tree algorithms which link analytic results to proposed strategies, and a lack of automated links between raw data and analytic profiles. These deficits originate from the traditional communication deficiencies between IT and sales and marketing departments, as well as a general avoidance of sales and marketing personnel to embrace data-driven associations, mathematical algorithms, and results-based solutions in favor of softer qualitative aspects of sales and marketing such as creative, customer relations, branding, and pressures from senior management.

An organization's raw data quality, analysis, reporting, and the resulting sales and marketing strategies vary widely depending on the products sold and the channels used. Channels are generally defined as Business to Business (B-to-B) and Business to Consumer (B-to-C). Generally B-to-B products are sold directly to a business, have a higher price point, and sell through higher cost-per-touch channels such as a sales force, trade shows, and other direct marketing techniques. B-to-C products are sold directly to a consumer or household, have a lower price point, and sell through lower cost-per-touch channels such as newspaper, direct mail, QR codes, mobile devices, and other mass market techniques. Companies may utilize both components, depending on the product offerings.

Non-profits are an example of a combination of B-to-B and B-to-C channels. This combination is usually defined by heavy relationship marketing techniques such as events and personal letters. While the marketing channels, techniques, and tactics may vary, each marketing approach can be tied back to a data-driven retention, acquisition, and penetration sales-and-marketing strategy.

Beyond varying marketing approaches, companies often offer multiple products with different price points, targeted to different customers. This type of transactional raw data is critical to sales-and-marketing strategies but not utilized by sales-and-marketing departments. The opportunity to understand who a customer is (profiles) combined with how a customer behaves (transactions) provides a useful 360° analysis. As a result of the varying marketing approaches in an environment of diverse products and price points, there is a need for a tool with the ability to incorporate all marketing approaches, techniques, and tactics to automatically generate retention, acquisition, and penetration strategies.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The disclosure provides systems and methods pertaining to the generation of sales and marketing strategies. One embodiment provides an aggregated sales and marketing analysis and strategy system. The system includes a processing engine that is coupled to a database and at least one client device associated with a GUI dashboard. The system performs the roles of analyzing raw sales and marketing data, generating one or more sales and marketing strategies based on information obtained through the analysis, and reporting the results of the analysis as well as the sales and marketing strategies to the GUI dashboard. The tool provides an automated, data-driven process that depends on the receipt of raw data, either input through the client device or extracted from an external data source, which has been cleansed, standardized, appended, coded, and aggregated. The resulting sales and marketing strategies focus on Retention, Acquisition and Penetration and are automatically generated through the application of a library of strategies, or a pre-written and automated algorithm decision tree, which matches data analysis to optimal strategies. The tool is entirely software based, and is not a step-by-step methodology which requires the judgment of personnel and/or experts to develop strategy. The tool is strategic and selection based on data, and therefore does not involve iterative customer testing and evaluation of outcomes and applications.

One embodiment provides a method of generating a sales and marketing strategy for retention, acquisition, and penetration using a sales and marketing analysis and strategy tool having a processing engine operatively coupled to a database and at least one client device. The method includes (1) receiving, at the database, sales and marketing data that has been cleaned, standardized, appended, coded, and aggregated into a useable format for analysis; (2) storing, by the database, the sales and marketing data; (3) analyzing, by the processing engine, the sales and marketing data; and (4) generating, by the processing engine, one or more sales and marketing strategies based on the analyzing.

Another embodiment provides a sales and marketing system. The sales and marketing system includes a database coupled to a processing engine, at least one user machine, and a GUI dashboard. The database stores sales and marketing data extracted from one or more external data sources, and the processing engine includes logic configured to analyze the sales and marketing data and generate one or more sales and marketing strategies.

Yet another embodiment provides a sales and marketing analysis and strategy tool. The tool includes a data processor configured to receive sales and marketing data from one or more external data sources and clean, standardize, append, code, and aggregate the sales and marketing data into a useable format for analysis. The tool also includes a database configured to receive and store the sales and marketing data from the data processor, a GUI dashboard operatively connected to a client machine, and a processing engine coupled with the database and the GUI dashboard. The processing engine includes logic configured to (1) analyze the sales and marketing data by creating indices based on established metrics, creating definitive sales and marketing profiles, creating market segments, or establishing benchmark metrics; (2) apply a pre-written and automated algorithm decision tree to generate one or more sales and marketing strategies relating to customer retention, prospect acquisition, and market penetration; and (3) report the sales and marketing strategies to the GUI dashboard in the form of reports relating to one or more of demographic profiles, transactional profiles, psychographic profiles, firmographic profiles, a 360° view, sales and marketing metrics, business metrics, and an ROI calculator.

Other embodiments are also disclosed, and additional objects, advantages and novel features of the technology will be set forth in part in the following description, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a schematic of an aggregated sales and marketing analysis and strategy system;

FIG. 2 provides a flow chart illustrating the operation process of the aggregated sales and marketing analysis and strategy system of FIG. 1;

FIG. 3 provides a schematic that illustrates an exemplary data input step of the process of FIG. 2;

FIG. 4 provides a schematic that illustrates an exemplary analysis step of the process of FIG. 2;

FIG. 5 provides a schematic that illustrates a exemplary strategy-generation step of the process of FIG. 2;

FIG. 6A provides a chart that illustrates a first portion of one embodiment of a pre-written and automated algorithm decision tree applicable to the strategy-generation step of FIG. 5;

FIG. 6B provides a chart that illustrates a second portion of the pre-written and automated algorithm decision tree of FIG. 6A;

FIG. 7 illustrates one embodiment of a GUI dashboard of the aggregated sales and marketing analysis and strategy system of FIG. 1; and

FIG. 8 illustrates an exemplary performance overview report with various profile components available through the GUI dashboard of FIG. 7.

### DETAILED DESCRIPTION

### I. The System

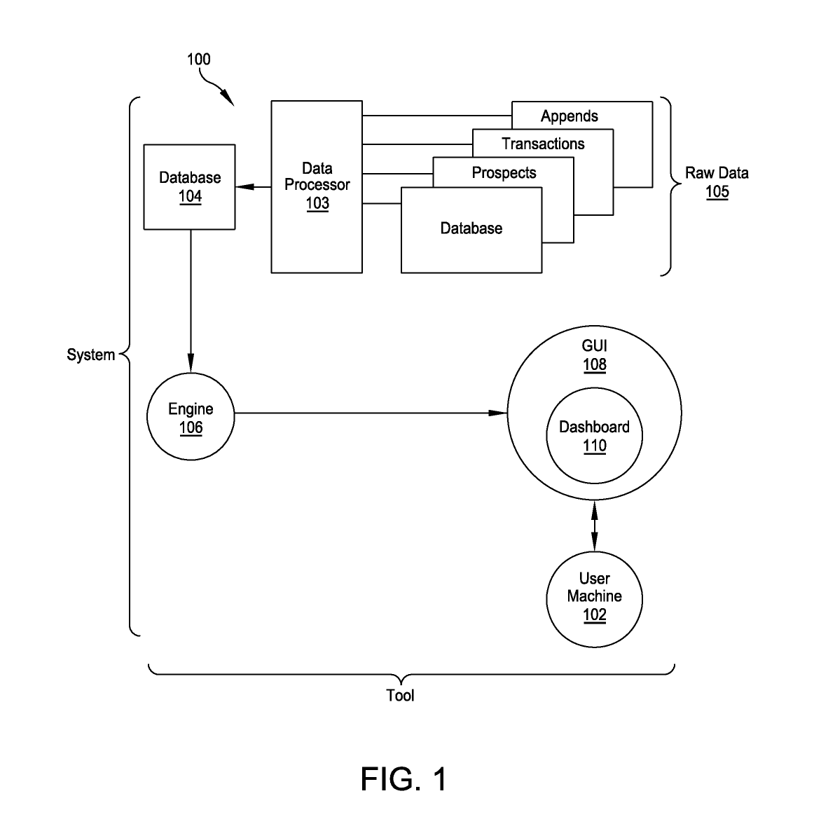

FIG. 1 illustrates one embodiment of an aggregated sales and marketing analysis and strategy system 100. System 100 is operative to allow a user (e.g., a client), operating a user machine 102 such as a personal computer, laptop, tablet or other processor-based device, to evaluate and analyze reports based on sales and marking data in order to deliver a set of directional, unbiased, and consistent strategies for customer retention, prospect acquisition, and market penetration.

While existing tools may combine to analyze, benchmark, and report the status of raw sales and marketing data, these tools, individually or separate, lack a crucial capability. None of these tools allow for the automated generation and reporting of sales and marketing strategies that advise the user how to best manage sales and marketing tasks and dollars moving forward.

System 100 provides a data processor 103, a database 104 that receives and stores raw data 105 relating to a client's customers, prospects, and transactions, and a processing engine 106 that provides logic for evaluating and analyzing the data 105 and generating sales and marketing strategies that focus on customer retention, prospect acquisition, and market penetration.

Database 104 and engine 106 may be accessible to user machine 102 via a network such as a local area network (LAN) or a wide area network (WAN) such as the Internet. Moreover, database 104 and engine 106 may be resident on a single processing platform or a distributed processing architecture as appropriate.

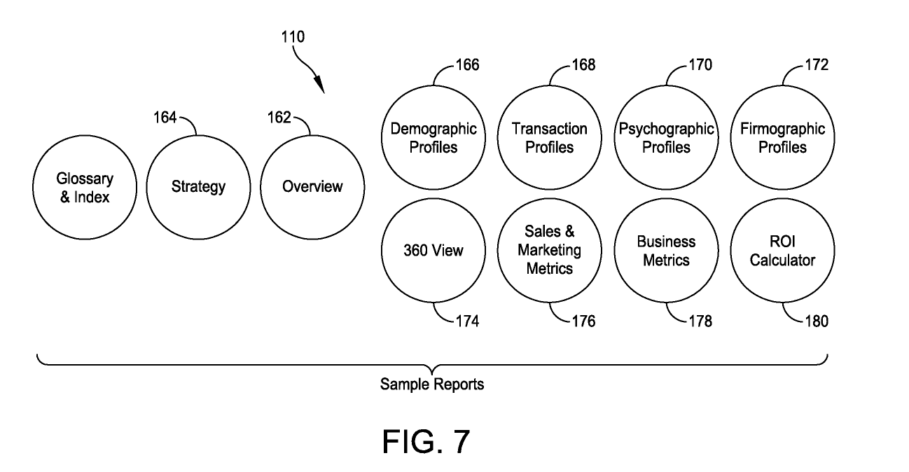

System 100 may also include a graphical user interface (GUI) 108 associated with a dashboard 110. GUI 108 may be incorporated within or made accessible to user machine 102. GUI 108 allows the user to understand and investigate further the analysis and strategies, as discussed below in reference to FIG. 7.

Raw data 105 may include a variety of sales and marketing information relating to each of the client's customers, prospects, and/or transactions, including demographic, firmographic, psychographic, and/or infographic data that is housed in customer files, client administration systems, web systems and/or email, internal marketing databases, or other data sources of information external to system 100. Sources may include legacy customer relationship management (CRM) systems, business intelligence (BI) tools, sentiment analysis tools, call center reports, sales pipeline tools, and more. Transaction data may include the purchase type, purchase date, purchase amount, number of products, length of relationship, or any other information relating to elements of a particular transaction.

Beyond customer-specific information, database 104 may store other general sales and marketing information such as interest rates, tax structures, legal guidelines, and/or data relating to sales and marketing best practices.

Engine 106 may access database 104 to obtain all necessary information before executing logic (i.e., code) to evaluate and analyze the raw data through a quantitative assessment of the client's performance. More specifically, engine 106 may utilize the data to create indices based on established performance metrics (e.g., cost per lead (CPL), return on investment (ROI), lifetime value (LTV), 80/20), compare those indices, calculate averages and percentages, develop customer profiles and market segments, understand customer relationships, analyze customers according to a variety of customer-value models (e.g., recency, frequency, monetary (RFM), forecast, regression), and establish benchmark metrics or key performance indicators (KPIs) to be used to evaluate the client's progress. Engine 106 may also formulate reports that detail the various components of the analysis and provide a foundation for strategic findings.

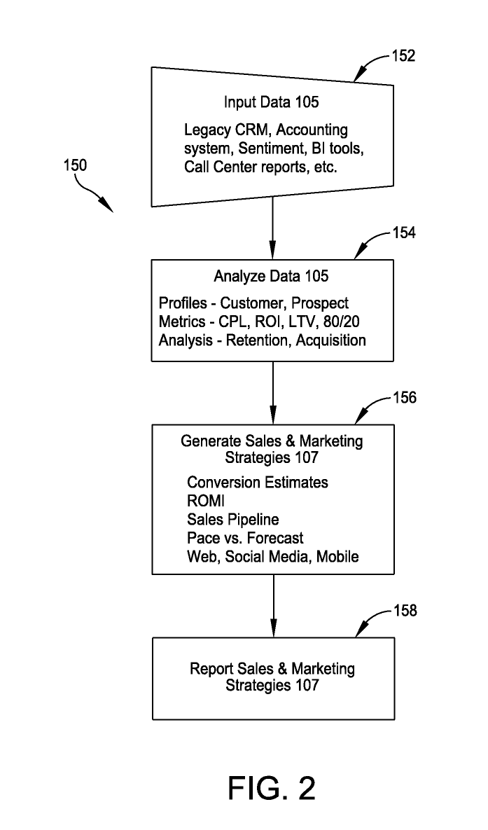

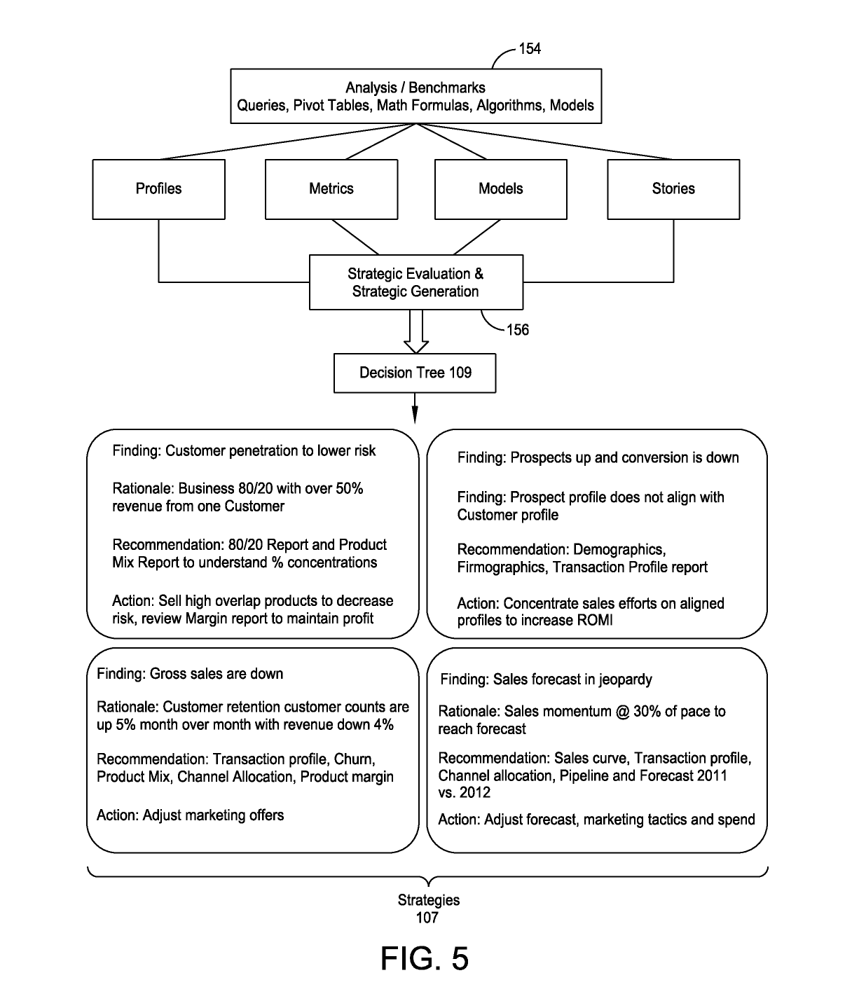

As discussed further in reference to FIGS. 2-8 below, the analysis and reporting discussed above allows the client's sales and marketing situation to be presented as unbiased metrics that, based on the client's business goals, may be used to generate sales and marketing strategies 107 (FIG. 5) for the client. That is, engine 106 may utilize the above findings to generate strategies 107 for, to name a few, Retention, Acquisition, and Penetration.

Such sales and marketing strategies 107 for Retention, Acquisition, and Penetration include Findings, Rationale, Recommendations, and Actions. Actions may include converting interested consumers to paying customers (conversion estimates), return on marketing investment (ROMI), sales pipelines, pace vs. forecast, and web, social media, and mobile marketing.

Information relating to raw data 105, the results of its analysis, and generated strategies 107 may be provided to the user through dashboard 110 presented on GUI 108. In one embodiment detailed in FIG. 7, dashboard 110 may provide several reports such as, for example, reports labeled overview 162, strategy 164, demographic profiles 166, transaction profiles 168, psychographic profiles 170, firmographic profiles 172, 360° view 174, sales and marketing metrics 176, business metrics 178, and ROI calculator 180 to allow the user to easily organize, view, and assimilate the data, analysis information (benchmarks, metrics, models), and the recommended sales and marketing strategies 107. Once populated, the reports may include drill-down links to supporting data in other reports. For ease of understanding, the reports provided through dashboard 110 may adhere to industry standard terms, concepts, and metrics of the sales and marketing industry. Furthermore, GUI dashboard 110 may be web-based and password protected to ensure access is limited and/or controlled.

### II. The Method

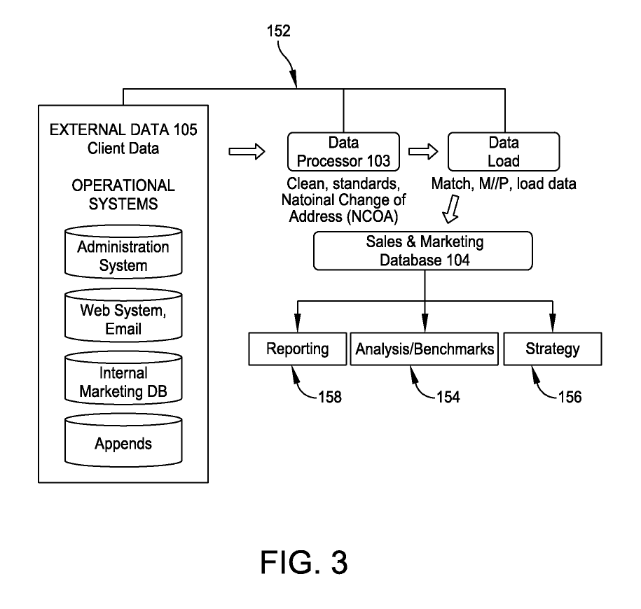

FIG. 2 provides a flow chart illustrating an exemplary process 150 for operating sales and marketing analysis and strategy system 100. Process 150 includes four key steps including data input (152), data analysis (154), generation of sales and marketing strategies (156), and reporting (158). The steps of process 150 are further detailed in FIGS. 3-8.

Process 150 initiates when data 105 is input (152) to database 104. As discussed above and shown in FIG. 3, raw sales and marketing data 105 may be input into user machine 102 or gathered/extracted from any appropriate external data source, including administration systems such as legacy CRM systems and accounting systems, BI tools, call center reports, sales pipeline tools, and more. Raw data 105 may include any relevant and/or appropriate sales and marketing data such as demographic, firmographic, infographic, and/or transactional data relating to the user/client's customers, prospects, and/or transaction history. Once input, data 105 may be scrubbed, standardized, appended, coded, aggregated, labeled, and/or categorized by data processor 103, and stored in database 104 in a manner ready for analysis.

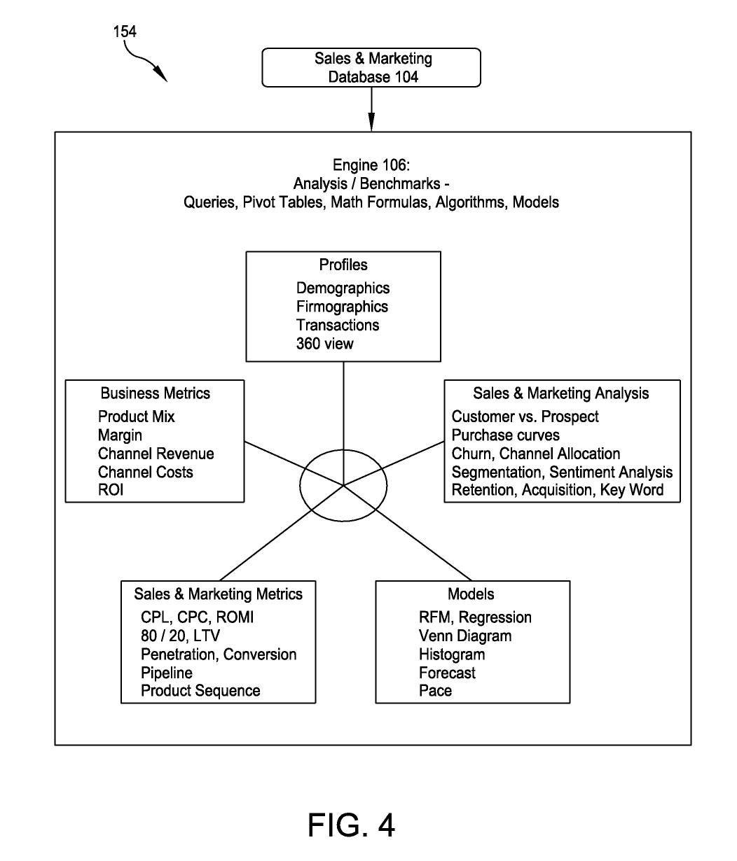

Returning to FIG. 2, after data input (152) is complete, engine 106 may analyze (154) data 105. For example, this analysis (154) may involve the creation of indices based on established performance metrics (e.g., CPL, ROI, LTV, 80/20), a comparison of those indices, the calculation of averages and percentages, the development of customer profiles and market segments, the explanation of customer relationships, the establishment of benchmark metrics or KPIs, and the development of revenue stories by using queries, pivot tables, and mathematical formulas. A number of customer-value models (e.g., RFM, forecast, regression) may be employed as part of the analysis (154). The graph shown in FIG. 4 depicts a variety of exemplary analysis metrics, models, and tools available to engine 106 during the analysis (154). As discussed above, this sales and marketing information gleaned from the analysis (154) may be reported to the user via dashboard 110 on GUI 108 (FIGS. 1 and 7).

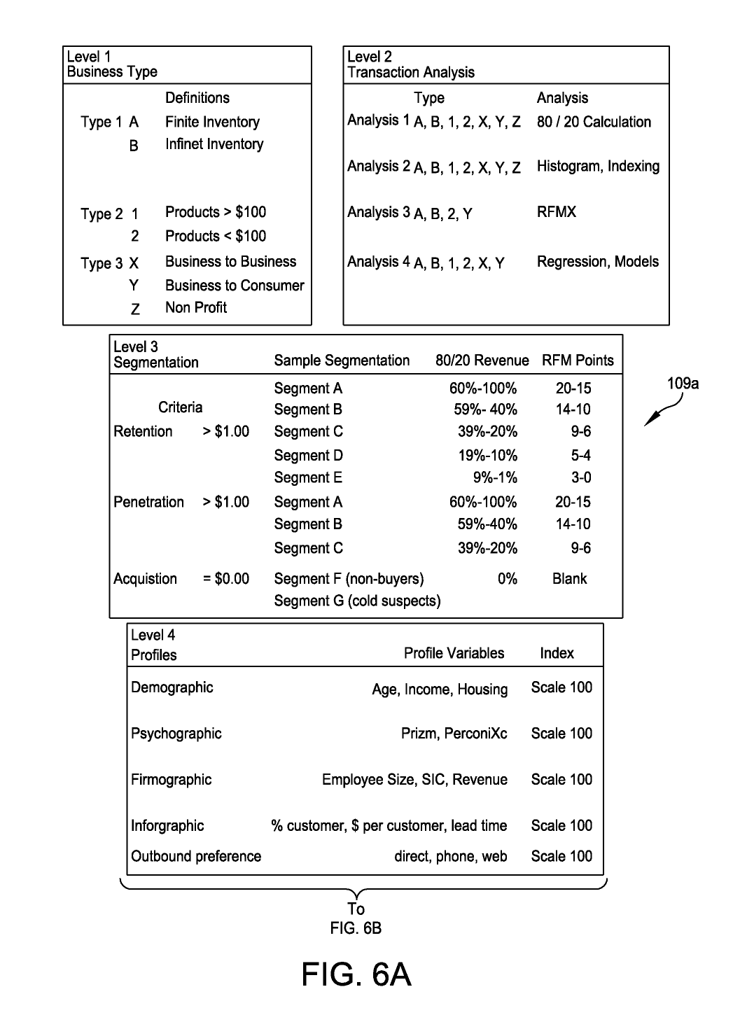

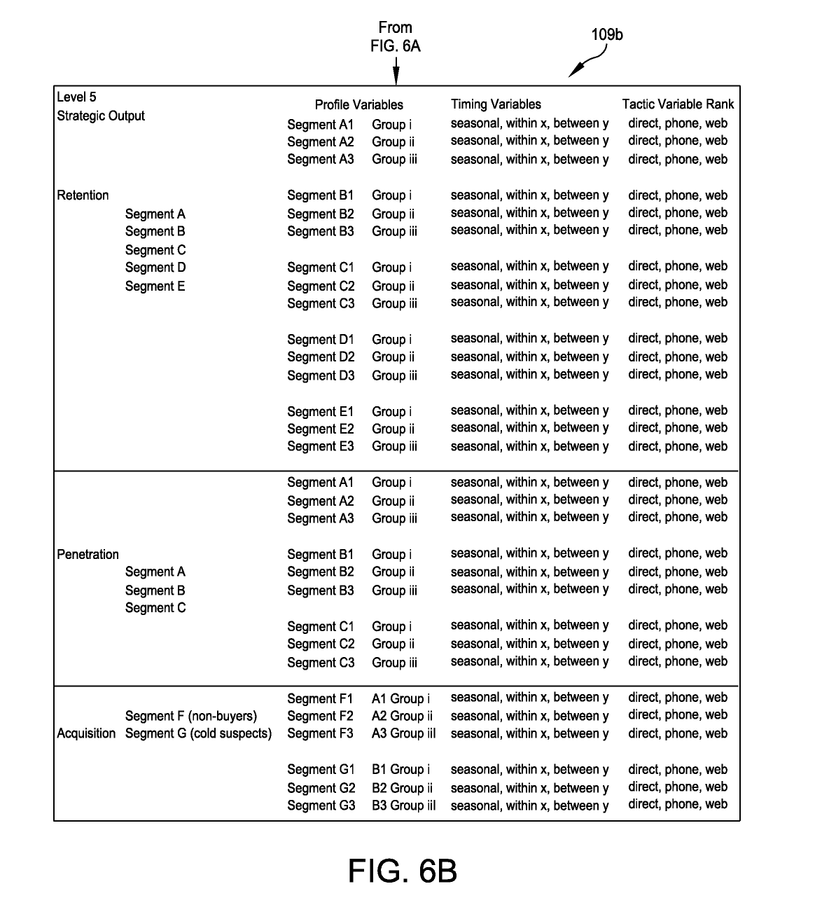

Returning again to FIG. 2, the analysis (154) may provide a basis for the automated generation of sales and marketing strategies (156). This process of generating sales and marketing strategies (156) is further detailed in the chart provided in FIG. 5. Specifically, based on the relationships, profiles, metrics, models, and revenue stories developed during the analysis (154), engine 106 may suggest sales and marketing strategies 107 that are dependent upon the client's business goals for growth, profit, maintenance, and loyalty. To complete this strategy-generation process (156), engine 106 may refer to a pre-written and automated algorithm decision tree 109. In this regard, processing engine 106 may utilize an automated selection process which matches the results of the data analysis (154) to one strategy or a set of optimal strategies 107, as defined in decision tree 109. FIGS. 6A and 6B provide one embodiment of decision tree 109, which graphically displays numerous algorithms used to complete the strategy-generation process (156). A first portion 109a of decision tree 109, shown in FIG. 6A, provides a graphical depiction of four levels of analysis relating to business type, transaction, and segmentation, as well as profile categories compartmentalized by demographic, psychographic, filmographic, infographic, and outbound contact preferences. This analysis feeds into a second portion 109b of decision tree 109, shown in FIG. 6B, which provides a number of exemplary and automated strategic outputs relating Retention, Acquisition, and Penetration.

Returning to FIG. 5, exemplary strategies 107 may relate to Retention, Acquisition, and Penetration, and for each may include Findings, Rationale, Recommendations, and Actions. Such actions may include, for example, conversion estimates, ROMI, sales pipelines, pace versus forecast summaries, and strategies for web, social media, and mobile marketing. FIG. 5 provides a graphical depiction of several sample strategic recommendations relating to revenue, prospect conversion, gross sales, and sales plans.

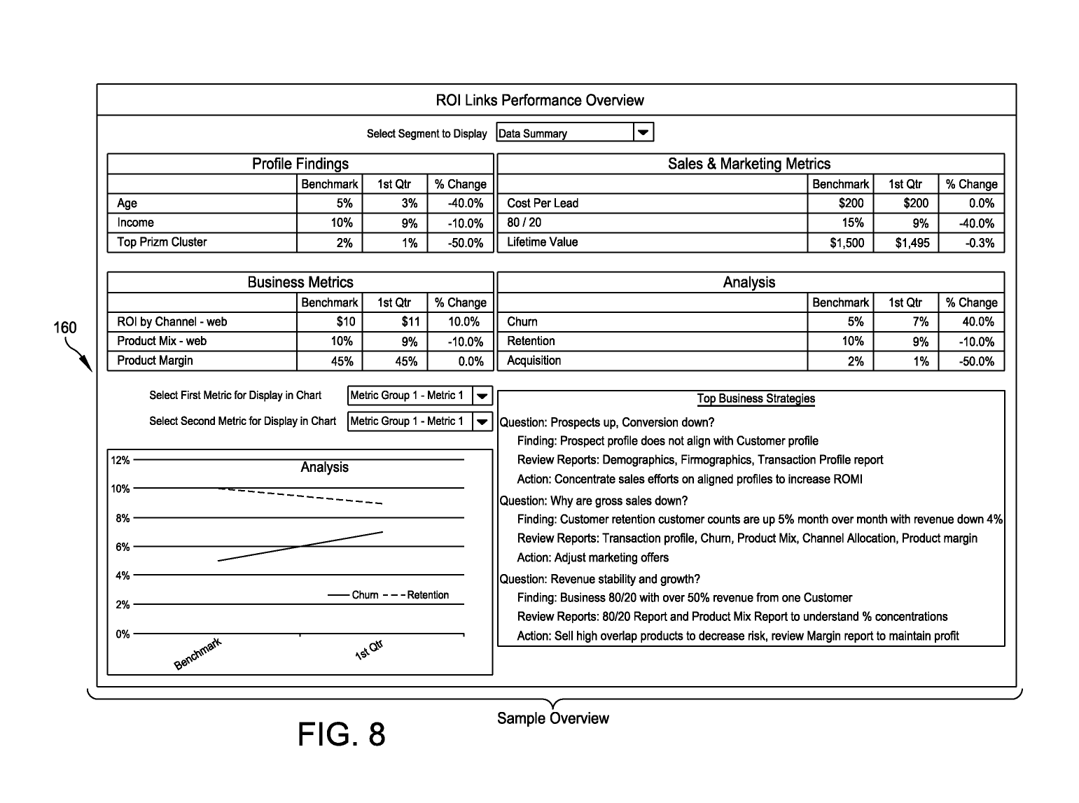

As discussed above in reference to FIGS. 1 and 2, raw data 105, analysis information and results, and suggested strategies 107 may be reported (158) to the user via an easy-to-navigate dashboard 110 on GUI 108. FIG. 7 graphically illustrates a number of exemplary reports that may be made available on dashboard 110. FIG. 8 provides one embodiment of a performance-overview report 160 of dashboard 110. Sample report 160 summarizes profile findings, sales and marketing metrics, business metrics, analysis, and lists the top sales and marketing strategies suggested by system 100. These components may be reviewed in detail by the user jumping to that particular report via drill down or jump buttons.

Using system 100, sales and marketing personnel need not be experts in database building, dashboard design, data analysis, and strategy creation. They may employ a single sophisticated system that uses customer, prospect, and transaction data to discern consistent, unbiased sales and marketing strategies focused on Retention, Acquisition, and Penetration. System 100 is capable of handling multiple business types (business-to-business, business-to-consumer, nonprofit), multiple product and price-point combinations, and virtually all industries. Because the analysis tool is automated, each data update to system 100 auto-updates the analysis, strategy, and reporting.

The sales and marketing strategies produced by system 100 focus on Retention, Acquisition and Penetration and are automatically generated through the application of a library of strategies, or a pre-written and automated algorithm decision tree, which matches data analysis to optimal strategies. The tool is entirely software based, and is not a step-by-step methodology which requires the judgment of personnel and/or experts to develop strategy. The tool provides strategic selection based on data, and therefore does not involve iterative customer testing and evaluation of outcomes and applications. The system also avoids strategic mistakes introduced by human error, preferences, politics, and/or other personnel factors.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method of generating a sales and marketing strategy for retention, acquisition, and penetration using a sales and marketing analysis and strategy tool having a processing engine operatively coupled to a database and at least one client device, the method comprising:
receiving, at said database, sales and marketing data that has been cleaned, standardized, appended, coded, and aggregated into a useable format for analysis;
storing, by said database, said sales and marketing data;
analyzing, by said processing engine, said sales and marketing data; and
generating, by said processing engine, one or more sales and marketing strategies based on said analyzing.

2. The method of claim 1, wherein said sales and marketing data is input to said client device or imported directly from an external data source.

3. The method of claim 1, wherein said analyzing comprises creating indices based on established metrics.

4. The method of claim 1, wherein said analyzing comprises creating definitive sales and marketing profiles including one or more of demographic profiles, infographic profiles, firmographic profiles, psychographic profiles, geographic profiles, transactional profiles, and 360° segment profiles.

5. The method of claim 1, wherein said analyzing comprises creating market segments.

6. The method of claim 1, wherein said analyzing comprises establishing benchmark metrics.

7. The method of claim 1, wherein said generating said sales and marketing strategies comprises applying a pre-written and automated algorithm decision tree to one or more results of said analyzing.

8. The method of claim 1, further comprising reporting said sales and marketing strategies to a dashboard associated with said client device.

9. The method of claim 8, wherein said dashboard provides reports relating to one or more of demographic profiles, transaction profiles, psychographic profiles, firmographic profiles, a 360° view, sales and marketing metrics, business metrics, and an ROI calculator.

10. A sales and marketing system, comprising:
a database coupled to a processing engine, at least one user machine, and a GUI dashboard, wherein said database stores sales and marketing data extracted from one or more external data sources, and wherein said processing engine includes logic configured to analyze said sales and marketing data and generate one or more sales and marketing strategies.

11. The system of claim 10, wherein said logic configured to analyze said sales and marketing data is configured to create indices based on established metrics.

12. The system of claim 10, wherein said logic configured to analyze said sales and marketing data is configured to create definitive sales and marketing profiles including one or more of demographic profiles, infographic profiles, firmographic profiles, psychographic profiles, geographic profiles, transactional profiles, and 360° segment profiles.

13. The system of claim 10, wherein said logic configured to analyze said sales and marketing data is configured to create market segments.

14. The system of claim 10, wherein said logic configured to analyze said sales and marketing data is configured to create benchmark metrics.

15. The system of claim 10, wherein said sales and marketing strategies relate to customer retention, prospect acquisition, and market penetration.

16. The system of claim 10, wherein said logic of said processing engine includes a pre-written and automated algorithm decision tree, and wherein said processing engine accesses said decision tree when generating said sales and marketing strategies.

17. The system of claim 16, wherein said sales and marketing strategies are reported as findings, rationale, recommendations, or actions.

18. The system of claim 17, wherein said processing engine reports said sales and marketing strategies to said GUI dashboard.

19. The system of claim 10, further comprising a data processor configured to clean, standardize, append, code, and aggregate said sales and marketing data before said sales and marketing data is stored in said database.

20. A sales and marketing analysis and strategy tool, comprising:
a data processor configured to receive sales and marketing data from one or more external data sources and clean, standardize, append, code, and aggregate said sales and marketing data into a useable format for analysis;
a database configured to receive and store said sales and marketing data from said data processor;
a GUI dashboard operatively connected to a client machine; and
a processing engine coupled with said database and said GUI dashboard, said processing engine including logic configured to:
analyze said sales and marketing data by creating indices based on established metrics, on creating definitive sales and marketing profiles, on creating market segments, or on establishing benchmark metrics;
apply a pre-written and automated algorithm decision tree to generate one or more sales and marketing strategies relating to customer retention, prospect acquisition, and market penetration; and
report said sales and marketing strategies to said GUI dashboard in the form of reports relating to one or more of demographic profiles, transactional profiles, psychographic profiles, firmographic profiles, a 360° view, sales and marketing metrics, business metrics, and an ROI calculator.
